(19) United States
(12) Patent Application Publication
(10) Pub. No.: US 2005/0219665 A1
(43) Pub. Date: Oct. 6, 2005

(54) Apparatus, method, and program for editing images

(75) Inventor: Kazuhiro Mino, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/067,679

(22) Filed: Mar. 1, 2005

(30) Foreign Application Priority Data
Mar. 1, 2004 (JP) 056209/2004

(51) Int. Cl. G06F 15/00

(52) U.S. Cl. 358/537; 358/1.18

(57) ABSTRACT

For generating a photo album of an event such as wedding, images to be inserted in image insertion areas in a template of the photo album can be selected easily. A professional photographer photographs the bride and groom of a wedding. Images are read from a developed film and stored in a file server. An editing screen is displayed including a template display field having the template therein and a catalog display field having a catalog of the images therein. When an operator selects any one of pages in the template, condition specification information sets comprising conditions for representing a state of images to be inserted in the image insertion areas in the selected page are referred to, and page fitting images that satisfy a common condition in the condition specification information sets are sifted from the catalog of the images.

### BACKGROUND OF THE INVENTION

1. Field of the Invention

The present invention relates to an image editing apparatus and an image editing method for selecting an image to be inserted in an image insertion area in a template. The present invention also relates to a program for causing a computer to execute the image editing method.

2. Description of the Related Art

As has been described in Japanese Unexamined Patent Publication No. 9(1997)-214868, a method has been proposed for generating a photo album, by reading images from a film with a film scanner, and by printing an image including a selected part of the images arranged in desired layout.

In addition, another method for generating a photo album has also been proposed in Japanese Unexamined Patent Publication No. 2003-182260. This method generates photo albums by printing desired images as photographs, and by inserting the photographs in photo mounting corners formed on photo album paper according to a size of the photographs and layout of the photo album.

Meanwhile, in order to generate a photo album of a wedding, a professional photographer sometimes photographs the bride and groom as well as attendants in front of a church as a venue for the wedding, or in front of a monument during the wedding. Images obtained in this manner are used for generating a photo album, and the photo album tells a story that can be enjoyed later, since the album traces the behavior of the bride and groom on their wedding day.

In order to generate a photo album, a professional photographer or an operator at a DPE store that provides a photo album generation service (hereinafter collectively referred to as an operator) stores images obtained by photography in an image server, and displays on display means such as a monitor of a workstation a catalog of the images stored in the image server and a template having an image insertion area used for photo album generation. The operator then selects one of the images to be inserted in the image insertion area from the catalog. At this time, the operator carries out image editing processing, such as processing for changing image quality (blurring or sharpness enhancement, for example), processing for image reshaping (such as rotation, resizing, and trimming), and processing for image restoration (such as red-eye correction and scar removal) on the selected image so that the image inserted in the image insertion area becomes attractive.

A photo album is generated by printing images edited in the above manner and pasting the images on photo album paper. A photo album can also be generated by printing composite images having a layout of the photo album generated from edited images inserted in image insertion areas of a template, as has been described in Japanese Unexamined Patent Publication No. 9(1997)-214868.

In the case where a photo album is generated in the above manner, hundreds of images are obtained by photography on an event such as a wedding. However, an operator is heavily burdened with selection of an image to be inserted in an image insertion area in a template from a catalog including the hundreds of images. Especially, photography is carried out for obtaining a plurality of images of the same scene, since some of the images may become unnecessary due to people with closed eyes or facing sideways therein, for example. Consequently, the burden on the operator is uselessly increased by inclusion of such unnecessary images in the catalog at the time of selection of the image to be included in the photo album.

### SUMMARY OF THE INVENTION

The present invention has been conceived based on consideration of the above circumstances. An object of the present invention is therefore to enable easy selection of an image to be inserted in an image insertion area in a template for generation of a photo album especially on an event such as wedding.

A first image editing apparatus of the present invention comprises:
display means for carrying out various kinds of display;
input reception means for receiving input of a plurality of images and a template used as photo album paper and comprising a plurality of pages each having at least one image insertion area, the template added with condition specification information comprising conditions for specifying a state of images to be inserted in the respective image insertion areas;
image sifting means for making judgment as to whether the condition specification information for all the image insertion areas in the template has a common condition and for sifting template fitting images that satisfy the common condition from the images by referring to the common condition in the case where a result of the judgment is affirmative;
display control means for displaying the template and a catalog of the images on the display means;
image sifting display means for carrying out distinctive display of the template fitting images in the catalog; and
image selection means for receiving selection of the images to be inserted respectively in the image insertion areas from the template fitting images.

The condition specification information comprises the conditions for determining a state of a subject in the images that are appropriate for insertion in the image insertion areas and an image quality thereof. More specifically, in the case of people as the subject, the condition specification information includes conditions for eliminating unnecessary images such as an image of people having closed eyes or red eyes, an image of people facing sideways, and an image not having a predetermined number of people. Furthermore, the condition specification information may comprise conditions for inclusion of necessary images, such as an image with a subject of a specific type (a church or the ocean, for example), an image of two people, an image of a person holding red flowers, and an image satisfying a criterion regarding graininess of skin color or regarding color information (brightness, lightness, and saturation of the subject, for example). The condition specification information may also include conditions for specifying a state of only a part of an image so that the image is sifted as long as the part such as a center part satisfies the conditions.

The first image editing apparatus of the present invention may further comprise page selection reception means for receiving selection of a desired one of the pages in the template. In this case, the image sifting means makes judgment as to whether the condition specification information for the image insertion area or areas in the selected page in the template has a common condition and sifts page fitting images that satisfy the common condition from the images by referring to the common condition in the case where a result of the judgment is affirmative. The display control means displays the selected page on the display means, and the image sifting display means carries out distinctive display of the page fitting images. The image selection means receives selection of the image or images to be inserted in the image insertion area or areas from the page fitting images.

The first image editing apparatus of the present invention may further comprise area selection reception means for receiving selection of a desired one of the image insertion areas. In this case, the image sifting means sifts area fitting images that agree with the condition specification information for the selected image insertion area from the catalog with reference to the condition specification information therefor, and the image sifting display means carries out distinctive display of the area fitting images. The image selection means receives selection of the image to be inserted in the selected image insertion area from the area fitting images.

A second image editing apparatus of the present invention comprises:
display means for carrying out various kinds of display;
input reception means for receiving input of a plurality of images and a template used as photo album paper and comprising a plurality of pages each having at least one image insertion area, the template having template condition specification information comprising a condition that is common for all the image insertion areas therein and specifies a state of images to be inserted in the respective image insertion areas, each of the pages having page condition specification information comprising a common condition for the image insertion area or areas therein, and each of the image insertion areas having area condition specification information comprising a condition therefor;
selection reception means for receiving selection of the template, a desired one of the pages in the template, and a desired one of the image insertion areas;
image sifting means for sifting template fitting images that agree with the template condition specification information for the template from the images by referring to the template condition specification information in the case where the template has been selected, for sifting page fitting images that agree with the page condition specification information for the selected page from the images with reference to the page condition specification information therefor in the case where the page has been selected, and for sifting area fitting images that agree with the area condition specification information for the selected image insertion area from the images with reference to the area condition specification information therefor in the case where the image insertion area has been selected;
display control means for displaying the selected template and the selected page together with a catalog of the images on the display means;
image sifting display means for carrying out distinctive display of the template fitting images, the page fitting images, and the area fitting images in the catalog; and
image selection means for receiving selection of the images to be inserted respectively in the image insertion areas from the template fitting images and the page fitting images, and for receiving selection of the image to be inserted in the selected image insertion area from the area fitting images.

A third image editing apparatus of the present invention comprises:
display means for carrying out various kinds of display;
input reception means for receiving input of a plurality of images and a template used as photo album paper and comprising a plurality of pages each having at least one image insertion area, each of the image insertion area having condition specification information comprising a condition for specifying a state of an image to be inserted therein;
relating means for carrying out relating between the images and the conditions in the condition specification information, with reference to the condition specification information for all the image insertion areas in the template;
result storing means for storing a result of the relating;
selection reception means for receiving selection of a desired one of the pages in the template;
image sifting means for making judgment as to whether the condition specification information for the image insertion area or areas in the selected page includes a common condition, and for sifting page fitting images that satisfy the common condition from the images by referring to the common condition and the result of the relating in the case where a result of the judgment is affirmative;
display control means for displaying the selected page and a catalog of the images on the display means;
image sifting display means for carrying out distinctive display of the page fitting images in the catalog; and
image selection means for receiving selection of the image or images to be inserted in the image insertion area or areas from the page fitting images.

In the third image editing apparatus of the present invention, the selection reception means may receive selection of a desired one of the image insertion areas. In this case, the image sifting means sifts area fitting images that agree with the condition specification information for the selected image insertion area from the images by referring to the condition specification information for the selected image insertion area and the result of the relating, and the image sifting display means carries out distinctive display of the area fitting images. The image selection means then receives selection of the image to be inserted in the selected image insertion area from the area fitting images.

A first image editing method of the present invention comprises the steps of:
receiving input of a plurality of images and a template used as photo album paper and comprising a plurality of pages each having at least one image insertion area, the template added with condition specification information comprising conditions for specifying a state of images to be inserted in the respective image insertion areas;
making judgment as to whether the condition specification information for all the image insertion areas in the template has a common condition and sifting template fitting images that satisfy the common condition from the images by referring to the common condition in the case where a result of the judgment is affirmative;
displaying the template and a catalog of the images;
displaying the template fitting images distinctively in the catalog; and
receiving selection of the images to be inserted respectively in the image insertion areas from the template fitting images.

A second image editing method of the present invention comprises the steps of:
receiving input of a plurality of images and a template used as photo album paper and comprising a plurality of pages each having at least one image insertion area, the template having template condition specification information comprising a condition that is common for all the image insertion areas therein and specifies a state of images to be inserted in the respective image insertion areas, each of the pages having page condition specification information comprising a common condition for the image insertion area or areas therein, and each of the image insertion areas having area condition specification information comprising a condition therefor;
receiving selection of the template, a desired one of the pages in the template, and a desired one of the image insertion areas;
sifting template fitting images that agree with the template condition specification information from the images by referring to the template condition specification information for the template in the case where the template has been selected, sifting page fitting images that agree with the page condition specification information for the selected page from the images with reference to the page condition specification information therefor in the case where the page has been selected, and sifting area fitting images that agree with the area condition specification information for the selected image insertion area from the images with reference to the area condition specification information therefor in the case where the image insertion area has been selected;
displaying the selected template and the selected page together with a catalog of the images;
displaying the template fitting images, the page fitting images, and the area fitting images distinctively in the catalog; and
receiving selection of the images to be inserted respectively in the image insertion areas from the template fitting images and the page fitting images, and receiving selection of the image to be inserted in the selected image insertion area from the area fitting images.

A third image editing method of the present invention comprises the steps of:
receiving input of images and a template used as photo album paper and comprising a plurality of pages each having at least one image insertion area, each of the image insertion areas having condition specification information comprising a condition for specifying a state of an image to be inserted therein;
carrying out relating between the images and the conditions in the condition specification information with reference to the condition specification information for all the image insertion areas in the template;
storing a result of the relating;
receiving selection of a desired one of the pages in the template;
making judgment as to whether the condition specification information for the image insertion area or areas in the selected page includes a common condition, and sifting page fitting images that satisfy the common condition from the images by referring to the common condition and the result of the relating in the case where a result of the judgment is affirmative;
displaying the selected page and a catalog of the images;
carrying out distinctive display of the page fitting images in the catalog; and
receiving selection of the image or images to be inserted in the image insertion area or areas from the page fitting images.

The first to third image editing methods of the present invention may be provided as programs for causing a computer to execute the image editing methods.

According to the first image editing apparatus and the first image editing method of the present invention, input of the template is received, and judgment is made as to whether the condition specification information for all the image insertion areas includes a common condition. If the result of judgment is affirmative, the template fitting images that satisfy the common condition are sifted from the images according to the common condition and displayed distinctively in the catalog. Therefore, an operator carrying out an editing operation can easily select the images to be inserted respectively in the image insertion areas in the template by simply referring to the template fitting images.

If selection of a desired one of the pages in the template is received, judgment is made as to whether the condition specification information for the image insertion area or areas in the selected page includes a common condition. If the result of judgment is affirmative, the page fitting images that satisfy the common condition are sifted from the images according to the common condition and displayed distinctively. Therefore, the operator carrying out the editing operation can easily select the image or images to be inserted in the image insertion area or areas in the selected page by simply referring to the page fitting images.

If a desired one of the image insertion areas is selected, the area fitting images that agree with the condition specification information for the selected image insertion area are sifted from the images according to the condition specification information and displayed distinctively. Therefore, the operator carrying out the editing operation can easily select the image to be inserted in the selected image insertion area by referring to the area fitting images.

Consequently, according to the first image editing apparatus and the first image editing method of the present invention, a burden on the operator can be reduced at the time of selection of the images to be inserted respectively in the image insertion areas in the template.

According to the second image editing apparatus and the second image editing method of the present invention, the template condition specification information for the template is referred to when the template is selected, and the template fitting images that agree with the template condition specification information are sifted from the images. If a desired one of the pages in the template is selected, the page condition specification information for the selected page is referred to, and the page fitting images are sifted from the images. Furthermore, if a desired one of the image insertion areas is selected, the area condition specification information for the selected image insertion area is referred to, and the area fitting images agreeing with the area condition specification information are sifted form the images. The template fitting images, the page fitting images, and the area fitting images are displayed distinctively in the catalog of the images. Therefore, an operator carrying out an editing operation can easily select the images to be inserted in the image insertion areas in the template and the image to be inserted in the selected image insertion area by referring to the template fitting images, the page fitting images, and the area fitting images. In this manner, a burden on the operator can be reduced at the time of selection of the images to be inserted respectively in the image insertion areas.

According to the third image editing apparatus and the third image editing method of the present invention, input of the template is received. All the images are then related to the conditions in the condition specification information with reference to the condition specification information for all the image insertion areas in the template, and the result of relating is stored. If selection of a desired one of the pages in the template is received, judgment is made as to whether the condition specification information for the image insertion area or areas in the selected page includes a common condition. If the result of judgment is affirmative, the page fitting images satisfying the common condition are sifted from the images according to the common condition and the result of relating. The page fitting images are displayed distinctively in the catalog of the images. Therefore, an operator carrying out an editing operation can easily select the image or images to be inserted in the image insertion area or areas in the selected page by simply referring to the page fitting images.

If selection of a desired one of the image insertion areas is received, the area fitting images that agree with the condition specification information therefor are sifted according to the condition specification information and the result of relating. By distinctively displaying the area fitting images, the operator can easily select the image to be inserted in the selected image insertion area with reference to the area fitting images.

Therefore, according to the third image editing apparatus and the third image editing method of the present invention, a burden on the operator can be reduced at the time of selection of the images to be inserted respectively in the image insertion areas. In addition, since the images are related to the conditions in the condition specification information in advance, the page fitting images and the area fitting images can be sifted fast with reference to the result of relating.

Note that the program of the present invention may be provided being recorded on a computer readable medium. Those who are skilled in the art would know that computer readable media are not limited to any specific type of device, and include, but are not limited to: CD's, RAM's ROM's, hard disks, magnetic tapes, and internet downloads, in which computer instructions can be stored and/or transmitted. Transmission of the computer instructions through a network or through wireless transmission means is also within the scope of this invention. Additionally, the computer instructions include, but are not limited to: source, object, and executable code, and can be in any language, including higher level languages, assembly language, and machine language.

### BRIEF DESCRIPTION OF THE DRAWINGS

FIG. 1 is a block diagram showing the configuration of an image editing system comprising an image editing apparatus of embodiments of the present invention;

FIG. 2 is a block diagram showing the configuration of a photo album editing PC;

FIG. 3 shows an example of an editing screen;

FIG. 4 shows how condition specification information sets are stored;

FIG. 5 shows how the condition specification information sets are added to image insertion areas;

FIG. 6 shows an example of the editing screen in which template fitting images are displayed differently from the other images;

FIG. 7 shows an example of layout information;

FIG. 8 is a flow chart showing a procedure carried out in a first embodiment;

FIG. 9 is a flow chart showing a procedure carried out for receiving photo album editing instructions in the first embodiment (part 1);

FIG. 10 is a flow chart showing the procedure carried out for receiving photo album editing instructions in the first embodiment (part 2);

FIG. 11 shows how condition specification information sets are added to a template in a second embodiment;

FIG. 12 is a flow chart showing a procedure carried out for receiving photo album editing instructions in the second embodiment;

FIG. 13 is a flow chart showing a procedure carried out for receiving photo album editing instructions in a third embodiment (part 1);

FIG. 14 is a flow chart showing the procedure carried out for receiving photo album editing instructions in the third embodiment (part 2); and

FIG. 15 shows an example of a relating table.

### DESCRIPTION OF THE PREFERRED EMBODIMENTS

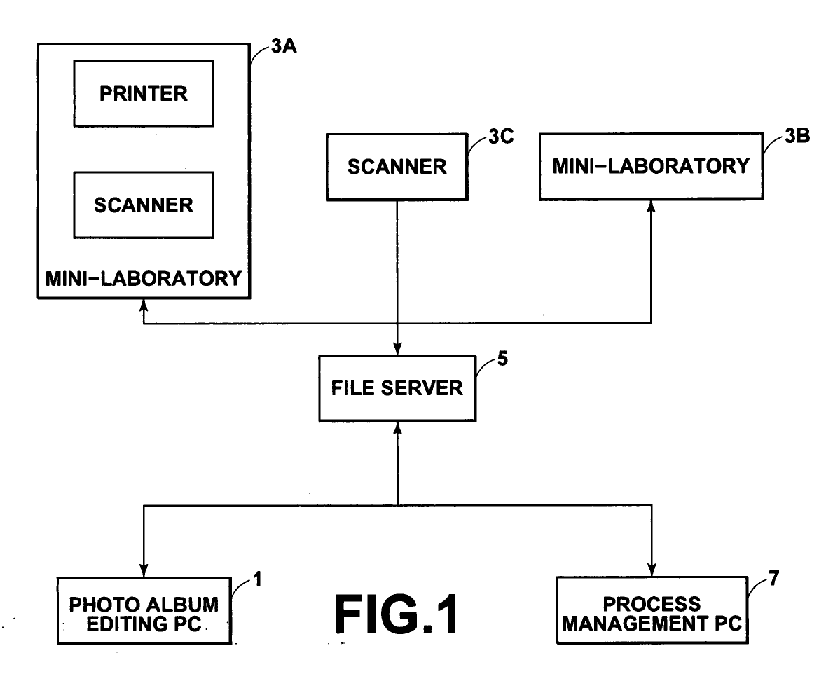

Hereinafter, embodiments of the present invention will be described with reference to the accompanying drawings. FIG. 1 is a block diagram showing the configuration of an image editing system having an image editing apparatus of the embodiments of the present invention. As shown in FIG. 1, the image editing system in the embodiments comprises a photo album editing personal computer (hereinafter referred to as the photo album editing PC) 1, a plurality (2, in this case) of mini-laboratories 3A and 3B, a scanner 3C, a file server 5, and a process management PC 7 connected to each other via a network. The photo album editing PC 1 has functions of the image editing apparatus as the embodiments of the present invention. Each of the mini-laboratories 3A and 3B has a scanner for obtaining image data sets representing images recorded on a developed negative or positive film or prints by reading the images from the film or prints, and a printer for printing the image data sets. The file server 5 has a large-capacity hard disc for storing the image data sets. The process management PC 7 manages processes of photo album generation.

In the embodiments, the case of a wedding as an event will be described. At the wedding, a professional photographer photographs the bride and groom who requested photo album generation (hereinafter referred to as a user) on the day of their wedding, and the photographer generates a photo album telling a story of the event by using the photographs. However, the event is not necessarily limited to a wedding.

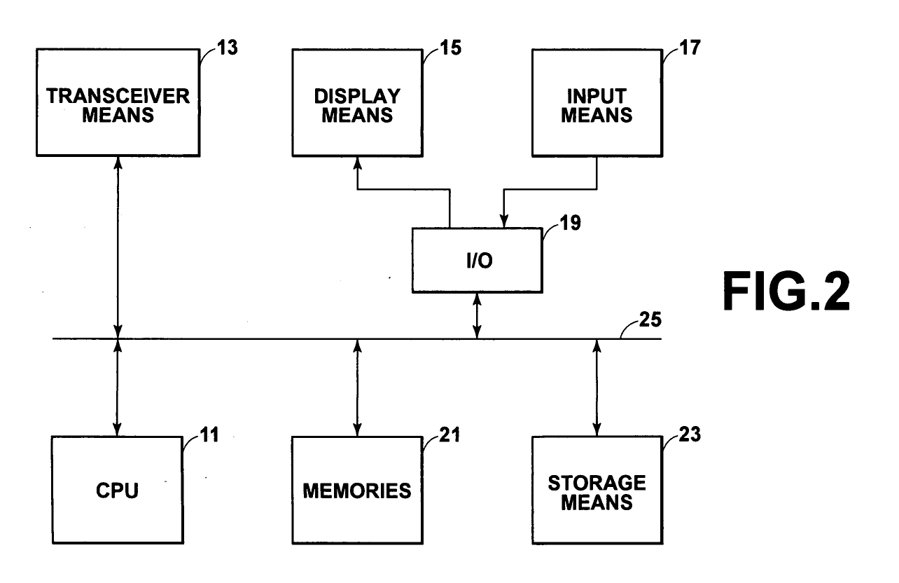

FIG. 2 is a block diagram showing the configuration of the photo album editing PC 1. As shown in FIG. 2, the photo album editing PC 1 comprises a CPU 11 (acting as the image sifting means, the display control means, the image sifting display means, and the relating means), transceiver means 13 for networking, display means 15, an I/O 19, memories 21 (the result storing means), and storage means 23. The CPU 11 controls the photo album editing PC 1. The transceiver means 13 sends and receives various kinds of information including the image data sets to and from the file server 5. The display means 15 displays various kinds of information such as the images and a template. The I/O 19 reads various kinds of information input by an operator via input means 17 (acting as the page selection reception means, the area selection reception means, and the image selection means) for delivering the information to the CPU 11. The I/O 19 also outputs a display instruction to the display means 15 according to an instruction from the CPU 11. The memories 21 comprise a ROM storing a program for operating the CPU 11 and various constants, and a RAM used by the CPU 11 as a workspace. The storage means 23 comprises a hard disc or the like for storing various kinds of information such as the image data sets.

A bus 25 connects the CPU 11 in the photo album editing PC 1 to peripheral circuits including the transceiver means 13, the I/O 19, the memories 21, and the storage means 23. In this manner, the CPU 11 can control the peripheral circuits. More specifically, the CPU 11 controls the transceiver means 13, the display means 15, the memories 21, and the storage means 23 to receive information such as the image data sets and a template data set that will be described later from the file server 5, to store the image data sets in the storage means 23, and to display a catalog and the template on the display means 15. In this manner, selection of images to be inserted in image insertion areas of the template and generation and transmission of image editing information to the file server 5 can be carried out in response to an instruction input from the input means 17 by the operator.

The photo album editing PC 1 receives photo album editing information comprising information on the template selected by the user who requested photo album generation and a user ID, when the operator carries out a photo album editing operation. The photo album editing PC 1 sends the photo album editing information to the file server 5, and receives the template data set, the image data sets, and guide image data sets to be inserted in the image insertion areas in the template from the file server 5. The photo album editing PC 1 then reduces the image data sets for generating the catalog of the images represented by the image data sets, and inserts guide images represented by the guide image data sets in the image insertion areas of the template represented by the template data set. In this manner, the photo album editing PC 1 displays an editing screen including the catalog and the template having the guide images inserted therein on the display means 15.

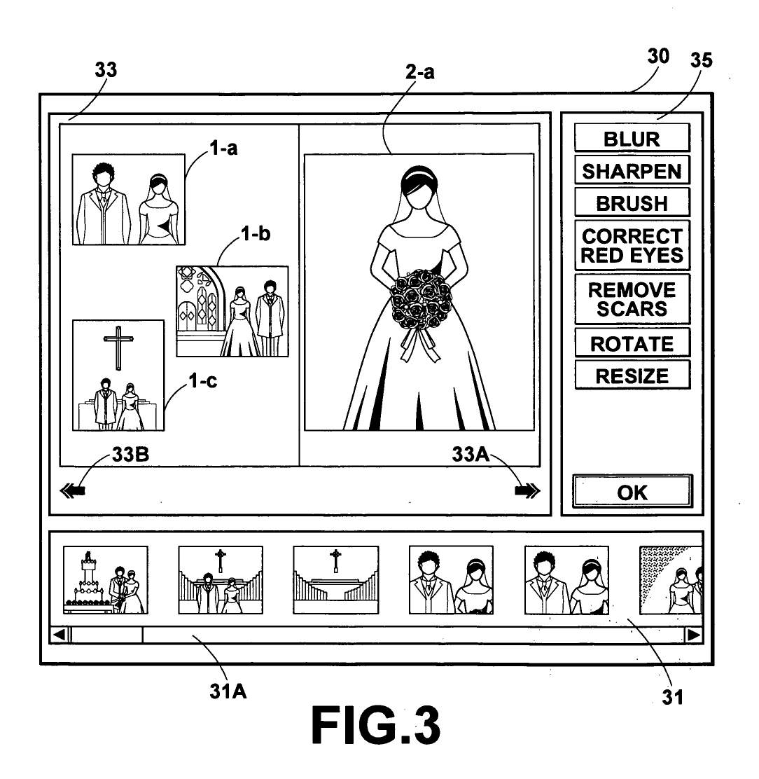

FIG. 3 shows an example of the editing screen. As shown in FIG. 3, an editing screen 30 includes a catalog display field 31 in which the catalog is displayed, a template display field 33 in which the template having the guide images inserted therein is displayed, and a tool box 35.

A scroll bar 31A is displayed in the catalog display field 31. By moving the scroll bar 31A to the right or left, a part of the images that cannot be displayed in one screen can be displayed.

In the example shown in FIG. 3, a template T1 displayed in the template display field 33 includes 4 image insertion areas named 1-a, 1-b, 1-c, and 2-a, all of which respectively have the guide images inserted therein. The template T1 has 4 pages. The image insertion areas 1-a to 1-c are included in page 1 while the image insertion area 2-a is included in page 2. Image insertion areas 3-a and 3-b are included in page 3 while image insertion areas 4-a and 4-b are included in page 4.

The guide images notify the operator who carries out the photo album editing operation of what composition the respective images should have in the corresponding image insertion areas in the template. In the case of photography for generating photo albums of events, the photography is carried out at the same place and in the same situation regardless of who a user as a requester is. For example, in the case of photography of brides and grooms in weddings, photography is carried out at a predetermined place in a hotel and in a predetermined situation such as exchange of marriage rings and cutting a wedding cake.

Therefore, by using the same composition for the images to be inserted in the image insertion areas in the template for all users that selected the same template, a quality of photo albums generated in the above manner can be constant. Consequently, the guide images can be illustrations representing the composition to be inserted in the image insertion areas, drawings, or sample images obtained by photography of a model in an actual place or in an actual situation, for example. In the embodiments, sample images generated by photographing a model are inserted in the image insertion areas.

In the template display field 33 are displayed arrow buttons 33A and 33B for changing a page of the template being displayed in the template display field 33 in the case where the template has a plurality of pages. The operator can change the page of the template to be displayed in the editing screen 30 by clicking the arrow button 33A or 33B.

In the tool box 35 are displayed buttons for carrying out image quality changing processing such as blurring, sharpening, and brushing, buttons for carrying out image restoration processing such as red-eye correction and scar removal, buttons for carrying out reshaping processing such as rotation and resizing, and an OK button for ending the processing.

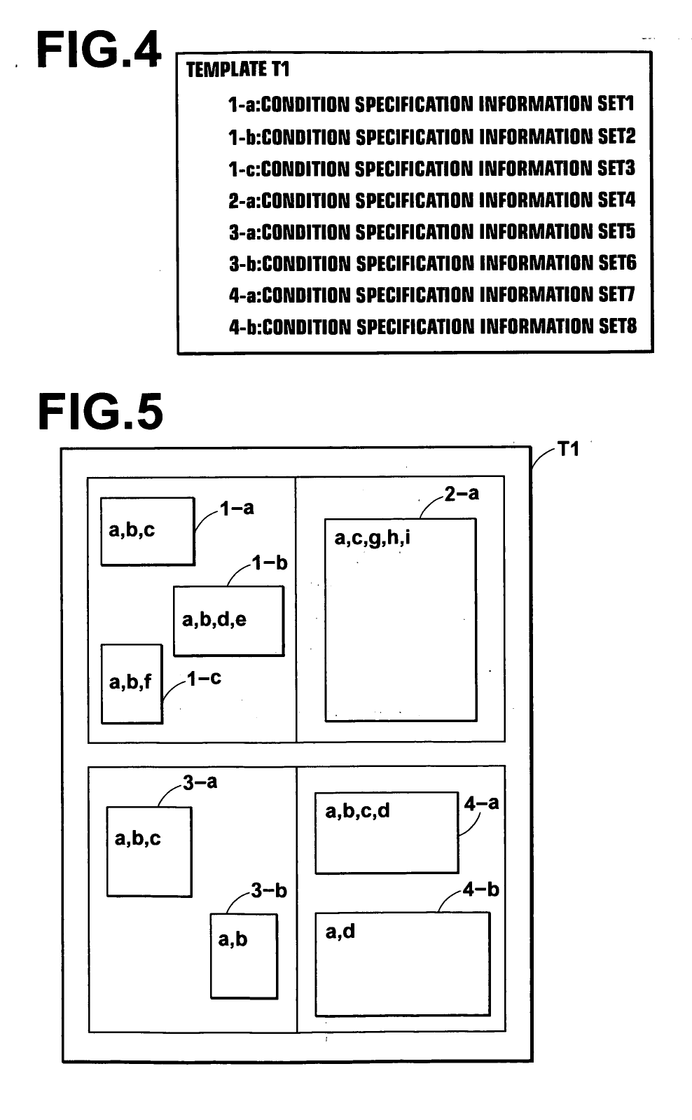

In a first embodiment of the present invention, the template data set is added with condition specification information sets for specifying a state of the images to be inserted in the respective image insertion areas of the template represented by the template data set. For example, condition specification information sets 1 to 8 are recorded in a header of the template data set for specifying the state of the images to be inserted in the image insertion areas 1-a, 1-b, 1-c, 2-a, 3-a, 3-b, 4-a and 4-b of the template T1 represented by the template data set, as shown in FIG. 4.

The condition specification information sets comprise conditions for determining the state of the images that are appropriate for insertion in the respective image insertion areas, according to the respective image insertion areas. More specifically, in the case where the subject is people, conditions for eliminating unnecessary images (such as an image of people with closed eyes or red eyes, an image of people facing sideways, and an image not including a predetermined number of people) are used as the condition specification information sets. Furthermore, the condition specification information sets may comprise conditions for inclusion of necessary images such as an image with a specific type of subject (a church or the ocean, for example), an image of two people, and an image of a person holding red flowers. The condition specification information sets may also include conditions for specifying a state of only a part of an image so that the image whose part such as a center part satisfies the condition can be sifted.

For example, in the case where the image insertion area 1-a of the template T1 needs to be filled with close-up of the faces of the bride and groom, the image to be selected for insertion therein should include the bride and groom not having red eyes caused by flash and not facing sideways.

Therefore, the condition specification information set 1 for the image insertion area 1-a includes conditions a to c, as shown below:
a. The image includes human faces.
b. The image does not include red eyes.
c. The people in the image do not face sideways.

In this embodiment, the condition specification information set 1 for the image insertion area 1-a of the template T1 has the conditions a to c, as shown in FIG. 5. The condition specification information set 2 for the image insertion area 1-b has the conditions a and b, as well as conditions d and e. The condition specification information set 3 for the image insertion area 1-c has a condition f in addition to the conditions a and b. The condition specification information set 4 for the image insertion area 2-a has the conditions a and c, as well as conditions g, h, and i. The condition specification information set 5 for the image insertion area 3-a has the conditions a, b and c. The condition specification information set 6 for the image insertion area 3-b has the conditions a and b. The condition specification information set 7 for the image insertion area 4-a has the conditions a, b, c, and d. The condition specification information set 8 for the image insertion area 4-b has the conditions a and d.

When the photo album editing PC 1 receives the template data set sent from the file server 5, the photo album editing PC 1 judges whether a common condition is included in the condition specification information sets for all the image insertion areas in the template represented by the template data set. If a result of the judgment is affirmative, the photo album editing PC 1 sifts template fitting images that satisfy the common condition from the images with reference to the common condition. The template fitting images are displayed distinctively in the catalog displayed in the catalog display field 31.

More specifically, the template fitting images are discriminated by changing a color of a frame thereof differently from that of the other images, or by preventing selection of the images other than the template fitting images, or by including only the template fitting images in the catalog, for example.

In this embodiment, the condition a is the common condition for all the image insertion areas 1-a to 1-c, 2-a, 3-a and 3-b, and 4-a and 4-b of the template T1. Therefore, the images satisfying the condition a are sifted from the images. The condition a represents inclusion of a human face. Therefore, the photo album editing PC 1 extracts human face areas from all the images represented by the image data sets. Extraction of the face areas can be carried out as extraction of circular skin-color areas in the images. The images from which the face areas have been extracted are sifted as the template fitting images that satisfy the condition a representing inclusion of human face.

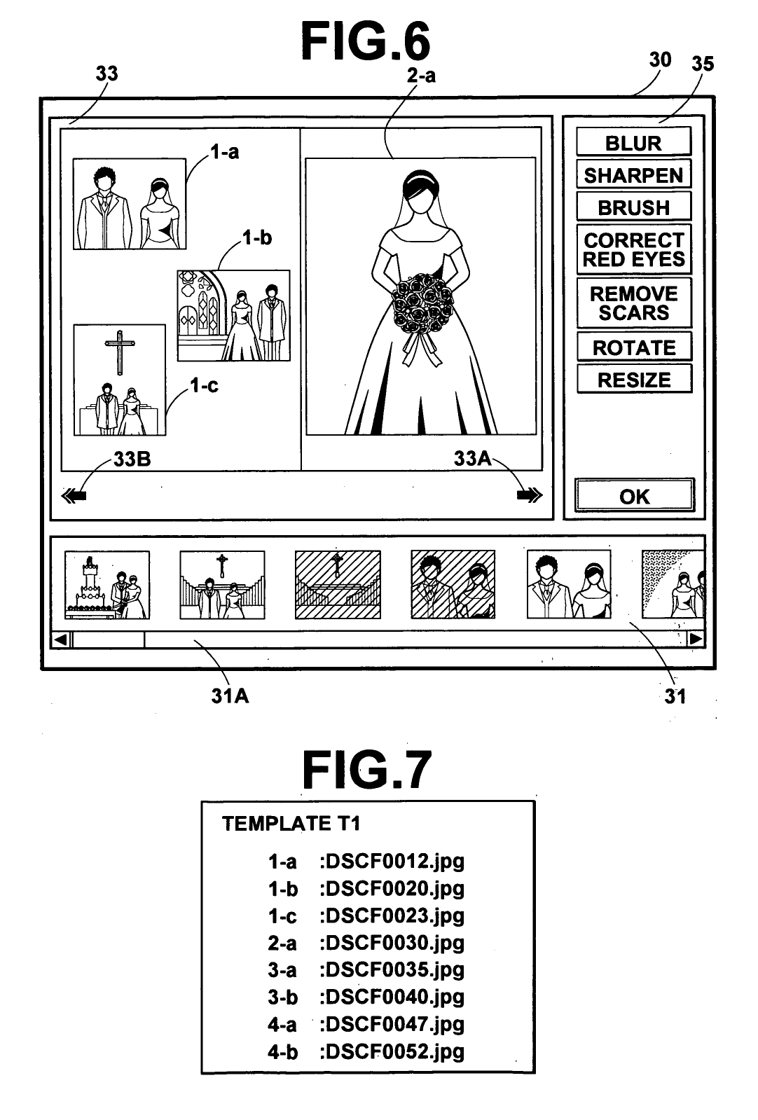

FIG. 6 shows an example of the editing screen wherein the template fitting images are displayed differently from the other images. As shown in FIG. 6, the photo album editing PC 1 displays the template fitting images that satisfy the common condition in the condition specification information sets for all the image insertion areas in the template by preventing selection of the images other than the template fitting images (represented by hatched images in FIG. 6) in the catalog displayed in the catalog display field 31 in the editing screen 30. The images other than the template fitting images may be selectable and included in the catalog. In this case, when the operator selects any one of the images other than the template fitting images, the operator may be requested to change to another one of the images or to carry out correction. Alternatively, a warning sound may be generated. In this embodiment, the state of the editing screen wherein the template fitting images are displayed distinctively is an initial state of the editing screen.

The template T1 has 4 pages, and 2 pages in the template T1 are shown in the template display field 33. In this embodiment, when the operator selects any one of the pages in the template T1 in the template display field 33 by clicking the page with use of the input means 17, the photo album editing PC 1 judges whether the condition specification information sets for all the image insertion areas in the selected page has a common condition. If a result of judgment is affirmative, the photo album editing PC 1 sifts page fitting images that satisfy the common condition from the images, with reference to the common condition.

For example, if the operator selects page 1, the photo album editing PC 1 judges whether the condition specification information sets for the image insertion areas 1-a to 1-c in the page in the template T1 have a common condition. If the result of judgment is affirmative, the page fitting images that satisfy the common condition are sifted from the images according to the common condition.

Since the conditions a and b are common among the condition specification information sets for all the image insertion areas 1-a to 1-c in page 1 in the template T1, the photo album editing PC 1 sifts the images that satisfy the conditions a and b as the page fitting images from the images. Since the condition b represents absence of red eyes, the photo album editing PC 1 detects positions of eyes from the face areas extracted from the template fitting images that satisfy the condition a, based on relationships between positions of eyes, mouths, and noses in human faces. The photo album editing PC 1 then judges whether or not white areas representing the whites are included in the detected eye positions, and sifts the images including the white areas. The photo album editing PC 1 further judges whether red areas are present in the white areas at the detected eye positions, and sifts the images having no red area as the page fitting images that satisfy the condition b representing absence of red eyes.

The photo album editing PC 1 then displays the page fitting images distinctively in the catalog display field 31.

In this embodiment, the operator may carry out the editing operation by changing the page of the template to be displayed in the template display field 33. In this case, whenever the page is selected, the page fitting images are sifted and displayed distinctively. However, it is preferable for the memories 21 to store which of the images has been selected as one of the page fitting images for the selected page. In this manner, when the same page is selected again, the page fitting images can be displayed distinctively in the catalog display field 31 with reference to the memories 21, without sifting the images again.

When the operator selects one of the image insertion areas by clicking the image insertion area with use of the input means 17, the photo album editing PC 1 refers to the condition specification information set for the selected image insertion area and sifts area fitting images that agree with the condition specification information set from the catalog displayed in the catalog display field 31 with reference to the condition specification information set.

In the case where the operator has selected the image insertion area 1-a, the condition specification information set for the image insertion area 1-a includes the conditions a, b, and c. Therefore, the photo album editing PC 1 sifts the images satisfying the conditions a, b, and c as the area fitting images from the images. Since the condition c represents people not facing sideways, the photo album editing PC 1 sifts the images each of which includes the face area with two eye positions as the area fitting images satisfying the condition c representing absence of people facing sideways from the page fitting images satisfying the conditions a and b that have been used for sifting. Therefore, the photo album editing PC 1 displays the area fitting images distinctively in the catalog display field 31.

In this embodiment, the operator may need to carry out the editing operation by changing the image insertion area to be selected. In this case, the area fitting images are sifted whenever the image insertion area is selected. For the image insertion area that has been selected once, which of the images has been selected as one of the area fitting images is preferably stored in the memories 21. In the case where the same image insertion area has been selected again, the area fitting images therefor are displayed distinctively in the catalog display field 31 with reference to the memories 21 without sifting the area fitting images again.

The condition specification information set 2 for the image insertion area 1-b includes the condition d representing presence of two people and the condition e representing presence of stained glass. Therefore, the area fitting images for the image insertion area 1-b can be sifted with reference to the conditions d and e. In this case, a correlation value may be calculated between the images represented by the image data sets and a template having a shape of stained glass. The images whose correlation value is equal to or higher than a predetermined threshold value may be sifted as the images satisfying the condition e.

The condition specification information set 3 for the image insertion area 1-c includes the condition f representing inclusion of a cross. The area fitting images for the image insertion area 1-c can be sifted with reference to the condition f. In this case, a correlation value may be calculated between the images represented by the image data sets and a template having a shape of a cross. The images whose correlation value is equal to or higher than a predetermined threshold value may be sifted as the images satisfying the condition f.

The condition specification information set 4 for the image insertion area 2-a includes the condition g representing a single person, the condition h representing white clothes of the person, and the condition i representing red flowers held by the person at the center thereof. The area fitting images for the image insertion area 2-a can be sifted according to the conditions g to i. In this case, after extraction of human face, the images each having only one face area below which is white and having a red area at the center thereof can be sifted as the area fitting images for the image insertion area 2-a.

The condition specification information sets are not necessarily limited to those described above. For example, in the case of sifting images representing class photos, a condition representing a predetermined number of people or more can be included in the condition specification information sets.

In the case where the condition specification information set for the selected image insertion area includes a plurality of conditions, the images satisfying not all the conditions but an indispensable part of the conditions may be sifted as the area fitting images. For example, regarding the condition b representing absence of red eyes for the image insertion area 1-a, the images satisfying the conditions a and c but not satisfying the condition b may be sifted as the area fitting images, since red eyes corresponding to the condition b can be corrected through image processing. In this case, the operator may select an image with red eyes as the image to be inserted in the image insertion area 1-a. Therefore, in the case where the image with red eyes has been selected, the operator is preferably requested to change to another one of the images or to correct the image. Alternatively, a warning sound may be generated.

Furthermore, the images may be sifted after predetermining points to be given for satisfaction of the respective conditions. In this case, the points are added at each time the corresponding condition is satisfied, and the images are sifted according to the points thereof exceeding a predetermined value.

For the conditions such as red eyes or closed eyes that can be corrected, the images may be corrected in advance before screening according to the condition specification information sets. In this case, the images having been subjected to the correction are included in the fitting images but the operator is preferably notified of the correction by addition of a frame or an arrow to each of the corrected images in the catalog display field 31, for example.

In the case of sifting the images having main figures such as bride and groom, the images may respectively include other people with closed eyes or red eyes around the main figures. In this case, since the main figures are often included at the center of the respective images, the images are screened by adopting the conditions such as no red eyes and no closed eyes for the people at the center of the images.

The condition specification information sets may include a condition on a position of a subject in the images, such as a condition that a person dressed in white is in a predetermined image area. Furthermore, the condition specification information sets may also include a condition on a degree of inclination of a subject, such as a condition that a person dressed in white is inclined by 60 degrees from a horizontal line.

The condition specification information sets may also include a condition defining an image quality such as graininess of human skin and color information (brightness, lightness, and saturation) of a subject to be included. For the graininess of skin, a frequency component of a face area is found, and a condition is included that the fitting images should have amplitude of frequency (representing the graininess) equal to or lower than a threshold value. For the remaining images whose frequency amplitude of the skin graininess exceeds the threshold value, processing for reducing the graininess may be carried out thereon so that the images can satisfy the condition of graininess.

In the case where the graininess of skin is found, the fitting images may be sorted in order of graininess (from lower to higher) so that the sorted images are included in the catalog in this order.

For the condition of excluding images having people facing sideways, the images may be sorted according to a degree of how much a face looks sideways so that the images can be included in the catalog in order of the degree (that is, from the lower degree of facing sideways). The degree may be detected by template matching using templates of faces facing different directions. In this case, the degree is determined according to the direction of the face in the template showing the largest agreement with the face in each of the images.

Moreover, a face and eyes may be detected in each of the images so that the direction of the face can be found by detecting positions of the eyes relative to the face, a position of the midpoint of the line connecting the eyes, and an angle of a perpendicular line passing the midpoint. In this case, the direction of the face is determined by the angle of the perpendicular line.

In addition, the direction of the face may be detected by machine learning results using boosting or a neural network, for example. In this case, recognizers which have learned directions of faces are prepared, and the direction of the face in each of the images is detected by using the recognizers. The direction of the face in each of the images is determined to be the direction of the face recognized by the recognizer outputting the largest response.

The operator carries out the photo album editing operation by inputting photo album editing instructions while viewing the template fitting images, the page fitting images, and the area fitting images displayed distinctively in the catalog display field 31. More specifically, the operator selects any one of the images having the same composition as the guide image inserted in the selected image insertion area from the template fitting images, the page fitting images, and the area fitting images displayed distinctively, and drags and drops the selected image by using the input means 17. In this manner, the operator inserts the selected image in the image insertion area. After the insertion, the operator selects the image insertion area, and edits the selected image inserted therein by clicking any one of the buttons in the tool box 35. For example, by clicking the button for rotation, the operator can rotate the image by 90 degrees in the clockwise direction. By clicking the button for resizing, a size of the image can be changed. Furthermore, by clicking the button for blurring or sharpening or brushing, a quality of the image can be changed. By clicking the button for red-eye correction or scar removal, the image can be restored.

In the case where the image inserted in the image insertion area includes a person or people, if the operator selects a face therein by using the input means 17 at the time of editing, a parameter for carrying out image processing may also be specified in order to improve skin color, reduce sharpness, or reduce graininess, for example. In the case where a person is holding red flowers, a parameter for improving saturation of the red color may also be specified. In this case, the tool box 35 has a button for specifying such a parameter.

In the case where the image having been selected for the image insertion area is sifted as one of the images agreeing with the condition specification information set for another one of the image insertion areas, prevention of selection of the image for the latter image insertion area is preferable in the catalog display field 31.

After selecting all the images to be inserted in the respective image insertion areas and editing all the selected images, the operator clicks the OK button to end the photo album editing operation using the template. In response to the clicking of the OK button by the operator, the photo album editing PC 1 generates the image editing information including file names of the selected images, information relating the file names of the images to be inserted in the respective image insertion areas to the corresponding image insertion areas, information on the processing to be carried out on the image data sets such as blurring, enlargement or reduction and red-eye correction, information representing a trimming range in the case of trimming, and information on a magnification ratio in the case of enlargement or reduction. The image editing information is sent to the file server 5.

The image editing information may be stored in the photo album editing PC 1 not only after clicking of the OK button by the operator but also temporarily for each order of photo album generation so that the image editing information can be sent regularly to the file server 5 at predetermined intervals. The image editing information may be generated and sent to the file server 5 at the time of generation of information regarding the processing for any one of the image insertion areas or regarding each of the pages in the template if the template comprises the pages.

In the case where the editing operation is temporarily suspended during selection of the images to be inserted in the respective image insertion areas, the suspension may be notified in the editing screen 30. Furthermore, a list or thumbnail images of orders being processed may be displayed on the display means 15 of the photo album editing PC 1 so that the operator is notified of the processing that has not been finished. In the case of suspension of the editing operation, the step to which the operation has been carried out may be stored so that the step is displayed first in the editing screen 30 at the time of resumption of the operation.

The file server 5 stores the image data sets obtained by reading the images recorded on the developed film by using the mini-laboratory 3A or 3B or the scanner 3C. The image data sets are stored in a folder generated for the user who requested the photo album generation. The file server 5 also stores template data sets to be used for photo album generation including the template data set representing the template for the user, as well as the guide image data sets representing the guide images to be inserted in the image insertion areas.

The file server 5 refers to the photo album editing information sent from the photo album editing PC 1, and sends the template data set representing the template selected by the user, the image data sets stored in the folder corresponding to the user ID, and the guide image data sets representing the guide images to be inserted in the image insertion areas in the selected template to the photo album editing PC 1.

When the image editing information is sent from the photo album editing PC 1, the file server 5 refers to the file names of the image data sets representing the selected images included in the image editing information, and carries out preparatory processing and editing processing on the selected image data sets for generating processed image data sets. The preparatory processing includes at least one of: brightness correction processing, color correction processing, and gradation correction processing on the selected image data sets. The editing processing includes the processing specified by the image editing information. More specifically, the editing processing includes the processing for image quality change such as blurring, sharpening, and brushing, the processing for reshaping the images such as trimming and enlargement or reduction, and the image restoration processing such as red-eye correction and blurring on the image data sets specified by the image editing information, in the case where the processing described above is specified in the image editing information.

The file server 5 generates layout information from the information relating the file names of the image data sets and the image insertion areas of the template included in the image editing information. FIG. 7 shows an example of the layout information for the template T1. As shown in FIG. 7, the layout information relates the names of the image data sets (DSCF0012.jpg, DSCF0020.jpg, DSCF0023.jpg, DSCF0030.jpg, DSCF0035.jpg, DSCF0040.jpg, DSCF0047.jpg, and DSCF0052.jpg) and the corresponding image insertion areas 1-a, 1-b, 1-c, 2-a, 3-a, 3-b, 4-a, and 4-b in the template T1. The file server 5 sends the processed image data sets and the layout information to either the mini-laboratory 3A or 3B.

The process management PC 7 receives information representing completion of the processes such as the photo album editing operation, printing, and photo album inspection input by the operator, in order to manage the processes regarding each order for photo album generation. In the case where the photo album has passed the inspection carried out by the operator for examining the quality of the generated photo album, the process management PC receives information thereon, and finishes the process management for the photo album. In the case where the photo album did not pass the inspection, the process management PC 7 receives an instruction for generating the photo album again.

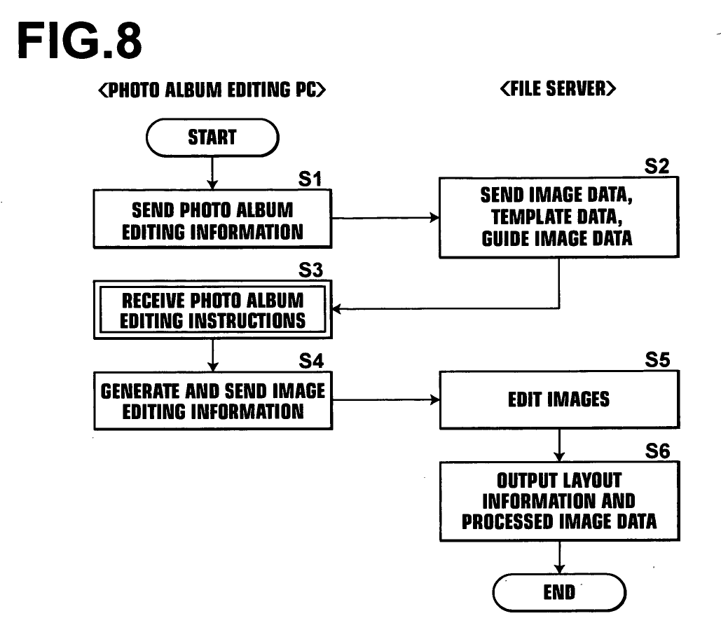

A procedure carried out in the first embodiment will be described next. FIG. 8 is a flowchart showing the procedure. The file server 5 has already stored the image data sets obtained by reading the images from the developed film recorded with photographs on the wedding of the user. The photo album editing information comprising the user ID and the information on the template selected by the user as well as information on the event regarding which the user has requested photo album generation have been input to the photo album editing PC 1. The template selected by the user is the template T1.

When the operator inputs an instruction to edit the photo album from the photo album editing PC 1, the procedure starts. The photo album editing PC 1 sends the photo album editing information including the user ID and the information on the template selected by the user to the file server 5 (Step S1).

The file server 5 receives the photo album editing information, and sends the image data sets stored in the folder corresponding to the user ID, the template data set representing the template selected by the user, and the guide image data sets representing the guide images to be inserted in the image insertion areas in the template to the photo album editing PC 1 (Step S2).

The photo album editing PC 1 receives the image data sets, the template data set, and the guide image data sets, and carries out a procedure for receiving the photo album editing instructions (Step S3).

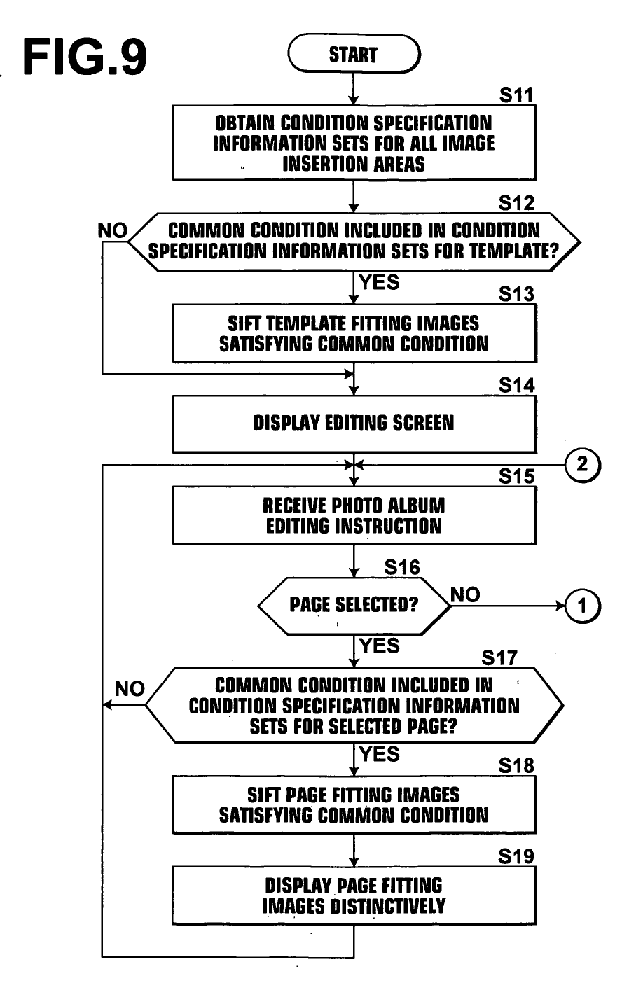

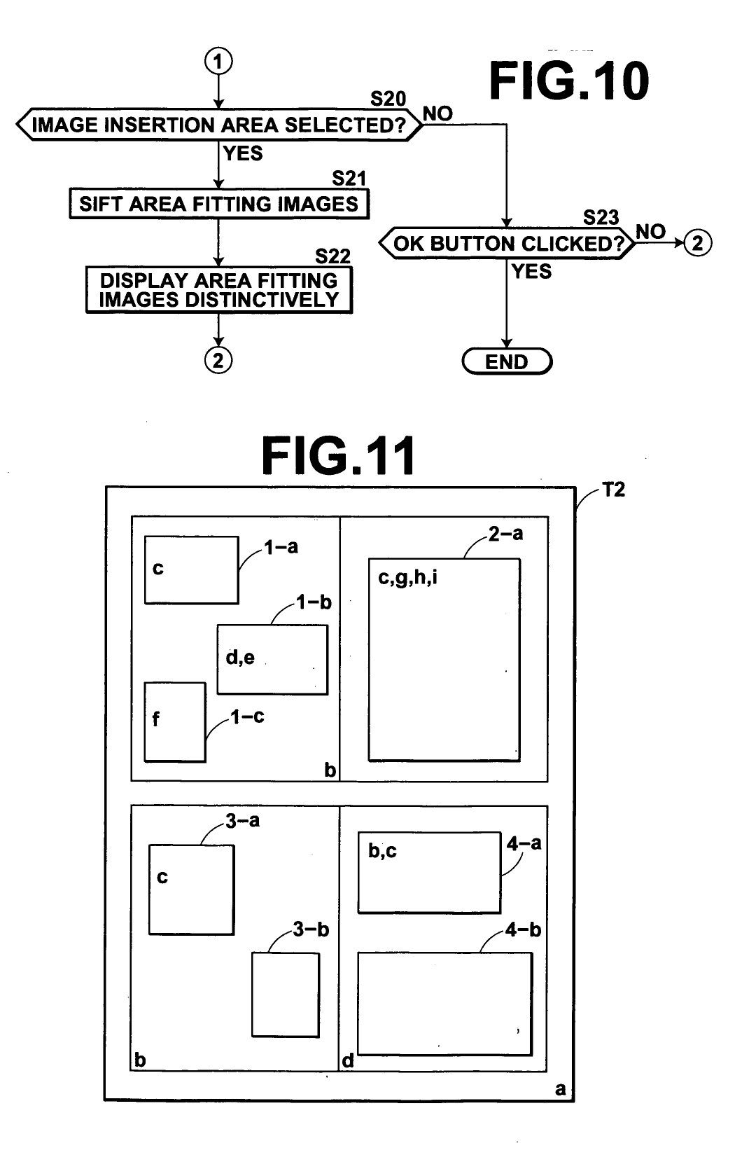

FIGS. 9 and 10 are a flow chart showing the procedure for receiving the photo album editing instructions. The photo album editing PC 1 obtains the condition specification information sets for all the image insertion areas in the template T1 (Step S11), and judges whether the condition specification information sets have a common condition (Step S12). If a result of judgment at Step S12 is affirmative, the photo album editing PC 1 sifts the template fitting images that satisfy the common condition (Step S13), and displays the editing screen 30 on the display means 15 (Step S14). The guide images represented by the guide image data sets are inserted in the corresponding image insertion areas in the template displayed in the template display field 33. The template fitting images are displayed distinctively in the catalog display field 31. If the result of judgment at Step S12 is negative, the procedure goes to Step S14 for display of the editing screen 30. In this case, the template display field 31 has the catalog of all the images.

The photo album editing PC 1 receives a photo album editing instruction from the operator viewing the template fitting images displayed distinctively (Step S15). If no template fitting images have been sifted, the photo album editing PC 1 receives the photo album editing instruction from the operator viewing the catalog of all the images.

Whether or not the operator has selected any one of the pages in the template T1 is then judged (Step S16). If a result of judgment at Step S16 is affirmative, whether the condition specification information sets for all the image insertion areas in the selected page has a common condition is judged (Step S17). If a result of judgment at Step S17 is affirmative, the page fitting images satisfying the common condition are sifted (Step S18). The page fitting images are displayed distinctively in the catalog display field 31 in the editing screen 30 (Step S19), and the procedure returns to Step S15. If the result at Step S17 is negative, the procedure also returns to Step S15.

If the result of judgment at Step S16 is negative, the photo album editing PC 1 judges whether or not the operator has selected any one of the image insertion areas (Step S20). If a result of judgment at Step S20 is affirmative, the photo album editing PC 1 sifts the area fitting images that agree with the condition specification information set for the selected image insertion area (Step S21). The photo album editing PC 1 displays the area fitting images distinctively in the catalog display field 31 in the editing screen 30 (Step S22) and the procedure returns to Step S15. If the result at Step S20 is negative, the photo album editing PC 1 judges whether the OK button has been clicked after selection of all the images to be inserted in the image insertion areas (Step S23). If a result of judgment at Step S23 is negative, the procedure returns to Step s15. If the result at Step S23 is affirmative, the procedure for receiving the photo album editing instructions is ended.

The photo album editing PC 1 generates the image editing information, and sends the image editing information to the file server 5 (Step S4 in FIG. 8).

The file server 5 receives the image editing information, and carries out the editing processing by referring to the file names of the selected image data sets included in the image editing information (Step S5). The file server 5 sends the processed image data sets generated through the editing processing and the layout information generated from the image editing information to either the mini-laboratory 3A or 3B (Step S6) to end the procedure in the first embodiment.

The mini-laboratory 3A or 3B receives the processed image data sets and the layout information, and prints the processed image data sets for generating prints thereof. The operator (or an operator dedicated to photo album binding) pastes the prints in print insertion areas in photo album paper corresponding to the template while referring to the layout information, and carries out binding to generate the photo album.

The operator in charge of quality control inspects the photo album generated in this manner. In the case where the photo album has passed the inspection, the photo album is sent to the user. In the case where the photo album did not pass the inspection, the operator instructs generation of the photo album again by using the process management PC 7.

As has been described above, in the first embodiment, the template fitting images satisfying the common condition are displayed distinctively in the case where a common condition is included in the condition specification information sets for all the image insertion areas in the template. In the case where any one of the pages is selected in the template, if the condition specification information sets for the image insertion areas in the selected page has a common condition, the page fitting images that satisfy the common condition are displayed distinctively. In the case where any one of the image insertion areas is selected, the area fitting images agreeing with the condition specification information set for the selected image insertion area are displayed distinctively. Therefore, with reference to the template fitting images, the page fitting images, and the area fitting images displayed distinctively, the operator can easily select the images to be inserted in the respective image insertion areas, and a burden on the operator can be reduced at the time of selection of the images.

A second embodiment of the present invention will be described next. In the first embodiment, the template data set is added with the condition specification information sets for the image insertion areas. However, in the second embodiment, condition specification information sets are added to a template, each page in the template, and each image insertion area in the template.

FIG. 11 shows how the condition specification information sets are added in the second embodiment. As shown in FIG. 11, a template T2 is added with a template condition specification information set including a condition a as a common condition for all image insertion areas in the template T2. The first page in the template T2 is also added with a page condition specification information set including a condition b as a common condition for image insertion areas in the first page. Image insertion areas 1-a, 1-b, and 1-c are added with area condition specification information sets respectively including a condition c, conditions d and e, and a condition f. The second page in the template T2 has only one image insertion area 2-a. Therefore, the image insertion area 2-a is added with an area condition specification information set including the condition c and conditions g, h, and i. The third page in the template T2 is added with a page condition specification information set including the condition b as a common condition for image insertion areas in the third page. An image insertion area 3-a is added with an area condition specification information set including the condition c. An image insertion area 3-b is not added with any area condition specification information set, since any image that satisfies the conditions a and b for the template and the third page can be inserted therein. The fourth page in the template T2 is added with a page condition specification information set including the condition a and a condition d for all image insertion areas in the fourth page. An image insertion area 4-a is added with an area condition specification information set including the conditions b and c. An image insertion area 4-b is not added with any area condition specification information set, since the image insertion area 4-b needs to be filled with any image that satisfies the conditions a and d for the template T2 and for the fourth page.

A procedure carried out in the second embodiment will be described below. In the second embodiment, only a procedure for receiving photo album editing instructions is different from the first embodiment. Therefore, only the procedure therefor is described.

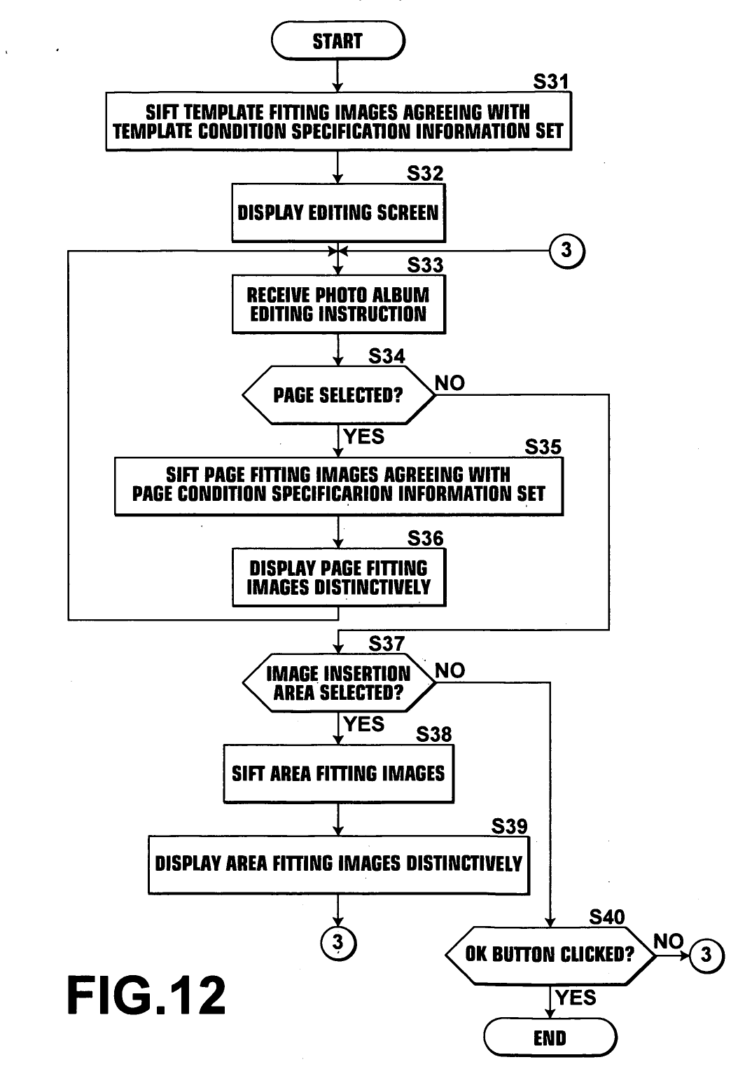

FIG. 12 is a flow chart showing the procedure. The photo album editing PC 1 sifts template fitting images that agree with the template condition specification information set for the template T2 (Step S31), and displays the editing screen 30 on the display means 15 (Step s32). The template T2 displayed in the template display field 33 is filled with guide images represented by guide image data sets. The template fitting images are displayed distinctively in the catalog display field 31.

The photo album editing PC 1 then receives an instruction input by an operator viewing the template fitting images that have been sifted and displayed distinctively (Step S33).

The photo album editing PC 1 judges whether the operator has selected any one of the pages in the template T2 (Step S34). If a result of judgment at Step S34 is affirmative, the photo album editing PC 1 sifts page fitting images that agree with the page condition specification information set of the selected page (Step S35), and displays the page fitting images distinctively in the catalog display field 31 in the editing screen 30 (Step S36). The procedure then returns to Step S33.

If the result at Step S34 is negative, the photo album editing PC 1 judges whether the operator has selected any one of the image insertion areas (Step S37). If a result of judgment at Step S37 is affirmative, the photo album editing PC 1 sifts area fitting images that agree with the area condition specification information set for the selected area (Step S38), and displays the area fitting images distinctively in the catalog display field 31 in the editing screen 30 (Step S39). The procedure then returns to Step S33. If the result at Step S37 is negative, the photo album editing PC 1 judges whether the operator has clicked the OK button after selection of all the images to be inserted in the image insertion areas (Step S40). If a result of judgment at Step S40 is negative, the procedure returns to Step S33. If the result at Step S40 is affirmative, the procedure for receiving the photo album editing instructions is ended.

As has been described above, according to the second embodiment, the template fitting images agreeing with the template condition specification information set added to the template are sifted and displayed distinctively. In the case where any one of the pages in the template has been selected, the page fitting images agreeing with the page condition specification information set added to the selected page are sifted and displayed distinctively. In the case where any one of the image insertion areas has been selected, the area fitting images agreeing with the area condition specification information set for the selected image insertion area are sifted and displayed distinctively. Therefore, the operator can easily select the images to be inserted respectively in the image insertion areas by referring to the images that have been sifted and displayed distinctively. Consequently, a burden on the operator can be reduced at the time of selection of the images to be inserted in the respective image insertion areas.

A third embodiment of the present invention will be described next. In the first embodiment, the images are sifted according to the condition or conditions in the condition specification information set or sets whenever the template, the page, or the image insertion area is selected. However, in the third embodiment, all images are related to conditions in condition specification information sets with reference to the condition specification information sets for all image insertion areas in a template, and a result of the relating is stored as a table in the memories 21. In the case where any one of pages or image insertion areas in the template is selected, images appropriate therefor are sifted according to the table.

A procedure carried out in the third embodiment will be described below. In the third embodiment, only a procedure for receiving photo album editing instructions is different from the first embodiment. Therefore, only the procedure therefor is described. The template T1 added with the condition specification information sets for the image insertion areas therein is used.

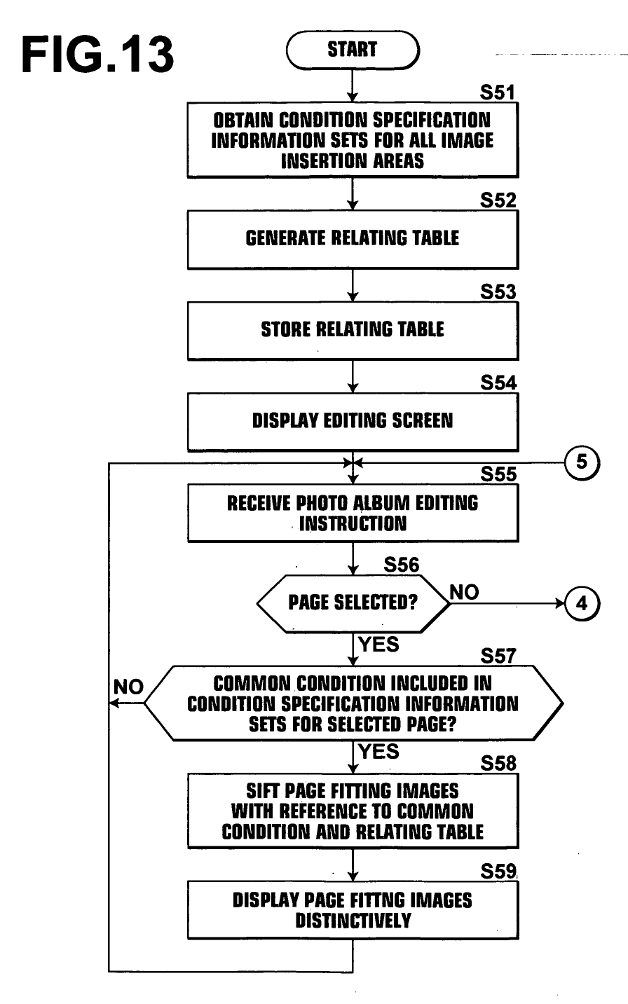

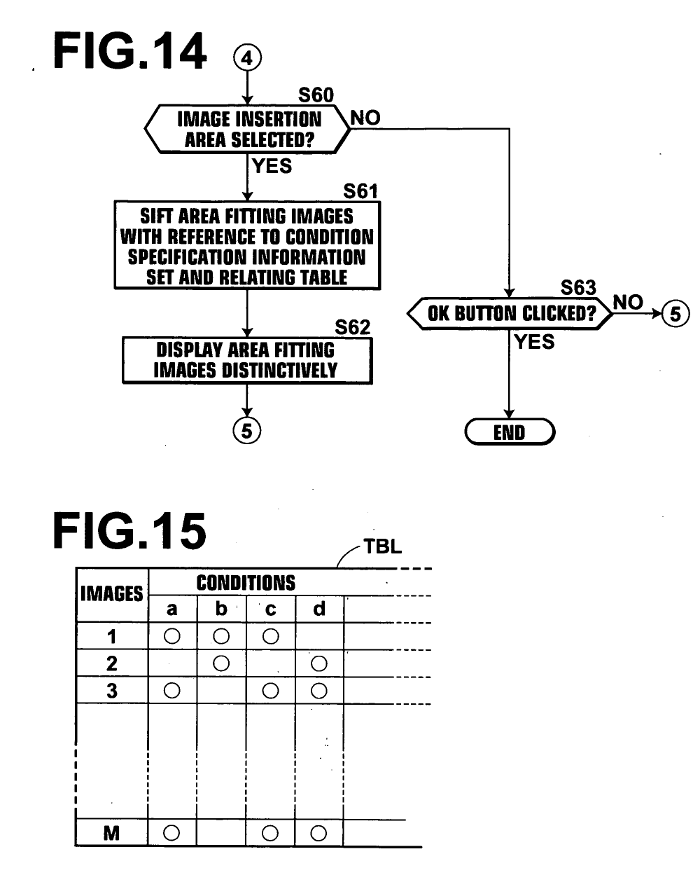

FIGS. 13 and 14 are flow charts showing the procedure. The photo album editing PC 1 obtains the condition specification information sets for all the image insertion areas in the template T1 (Step S51), and relates the images represented by the image data sets to the conditions included in the condition specification information sets with reference to the condition specification information sets for all the image insertion areas in the template T1. The photo album editing PC 1 generates a table representing a result of the relating (Step S52), and stores the table in the memories 21 (Step S53).

FIG. 15 shows an example of the table. As shown in FIG. 15, a relating table TBL relates the images sent from the file server 5 (the quantity of the image data sets representing the images is represented by M) to the conditions in the condition specification information sets. The condition or conditions satisfied by each of the images are represented by a circle or circles.

The photo album editing PC 1 displays the editing screen 30 on the display means 15 (Step S54). The image insertion areas in the template T1 displayed in the template display field 33 are filled with the guide images represented by the guide image data sets. All the images are displayed as the catalog in the catalog display field 31. The photo album editing PC 1 receives a photo album editing instruction input by an operator viewing the catalog (Step S55).

The photo album editing PC 1 judges whether the operator has selected any one of the pages in the template T1 (Step S56). If a result of judgment at Step S56 is affirmative, the photo album editing PC 1 then judges whether the condition specification information sets for all the image insertion areas in the selected page have a common condition (Step S57). If a result of judgment at Step S57 is affirmative, the photo album editing PC 1 sifts the page fitting images that satisfy the common condition by referring to the common condition and the relating table TBL (Step S58). More specifically, if the common condition is the condition a, the images having the circle corresponding to the condition a in the relating table TBL are sifted as the page fitting images. The page fitting images are displayed distinctively in the catalog display field 31 in the editing screen 30 (Step S59), and the procedure returns to Step S55. If the result at Step S57 is negative, the procedure also returns to Step S55.

If the result at Step S56 is negative, whether the operator has selected any one of the image insertion areas is judged (Step S60). If a result of judgment at Step S60 is affirmative, the area fitting images that agree with the condition specification information set for the selected image insertion area are sifted with reference to the relating table TBL and the corresponding condition specification information set (Step S61), and the area fitting images are displayed distinctively in the catalog display field 31 in the editing screen 30 (Step S62). The procedure then returns to Step S55. If the result at Step S60 is negative, whether the operator has clicked the OK button after selection of all the images to be inserted respectively in the image insertion areas is judged (Step S63). If a result of judgment at Step S63 is negative, the procedure returns to Step S55. If the result at Step S63 is affirmative, the procedure for receiving the photo album editing instructions is ended.

As has been described above, in the third embodiment, the condition specification information sets for all the image insertion areas in the template are referred to for generating the relating tale TBL that relates all the images with the corresponding conditions in the condition specification information sets. In the case where any one of the pages in the template has been selected and the condition specification information sets for the image insertion areas in the selected page have a common condition, the page fitting images satisfying the common condition are sifted and displayed distinctively according to the common condition and the relating table TBL. In the case where any one of the image insertion areas has been selected, the area fitting images agreeing with the condition specification information set for the selected image insertion area are sifted and displayed distinctively according to the condition specification information set and the relating table TBL. Therefore, the operator can easily select the images to be inserted respectively in the image insertion areas by referring to the page fitting images and the area fitting images displayed distinctively. Consequently, a burden on the operator can be reduced at the time of selection of the images to be inserted in the respective image insertion areas in the template. Furthermore, since the images are related in advance to the corresponding conditions in the condition specification information sets, the page fitting images and the area fitting images can be sifted fast with reference to the relating table.

In the embodiments described above, the processed image data sets of the selected images are printed by the mini-laboratory 3A or 3B, and the operator pastes the prints on the photo album paper corresponding to the template for generating the photo album. However, the file server 5 may generate a composite image data set representing an image (a photo album image) having the images selected by the operator and inserted in the image insertion areas in the template by combining the processed image data sets and the template data set. The composite image data set is output to the mini-laboratory 3A or 3B.

If the mini-laboratory 3A or 3B prints the composite image data set generated in this manner, the photo album can be generated by simply binding the print of the photo album image, without pasting the prints on the paper.

In the above-described embodiments, the photo album is generated by using the image data sets obtained by reading the images recorded on the developed film. However, a photo album can be generated by using image data sets obtained by a digital camera. In this case, the file server 5 comprises a media drive for reading the image data sets from a recording medium such as a memory card storing the image data sets obtained by photography. The image data sets read from the recording medium by the media drive are stored in the file server 5. A photo album can also be generated by using image data sets obtained by a camera-embedded mobile phone. In this case, the image data sets sent from the mobile phone via a mobile phone network are stored in the file server 5.

In the above-described embodiments, the file server 5 carries out the preparatory processing only on the image data sets selected by the operator using the photo album editing PC 1. However, all the image data sets may be stored in the file server 5 after the preparatory processing carried out thereon when the image data sets are received from the mini-laboratory 3A or 3B or from the scanner 3C. Furthermore, the photo album editing PC 1 may carry out the preparatory processing on all the image data sets sent from the file server 5 or on the image data sets selected for the photo album generation.

In each of the embodiments as described above, the photo album editing PC 1 or the file server 5 may generate, based on layout information, data (album data) including a user image inserted in a template, and the data may be sent to a server or like, which can be accessed by the user, and stored. Accordingly, the user can check whether the photo album will be successfully produced before actual production of the photo album. Further, in this case, the user may select whether the photo album is produced by using the album data or the photo album is reedited.

1. An image editing apparatus comprising:
display means for carrying out various kinds of display;
input reception means for receiving input of a plurality of images and a template used as photo album paper and comprising a plurality of pages each having at least one image insertion area, the template added with condition specification information comprising conditions for specifying a state of images to be inserted in the respective image insertion areas;
image sifting means for making judgment as to whether the condition specification information for all the image insertion areas in the template has a common condition and for sifting template fitting images satisfying the common condition from the images by referring to the common condition in the case where a result of the judgment is affirmative;
display control means for displaying the template and a catalog of the images on the display means;
image sifting display means for carrying out distinctive display of the template fitting images in the catalog; and
image selection means for receiving selection of the images to be inserted respectively in the image insertion areas from the template fitting images.

2. The image editing apparatus according to claim 1 further comprising page selection reception means for receiving selection of a desired one of the pages in the template,
the image sifting means making judgment as to whether the condition specification information for the image insertion area or areas in the selected page in the template has a common condition and sifting page fitting images satisfying the common condition from the images by referring to the common condition in the case where a result of the judgment is affirmative,
the display control means displaying the selected page on the display means,
the image sifting display means carrying out distinctive display of the page fitting images, and
the image selection means receiving selection of the image or images to be inserted in the image insertion area or areas from the page fitting images.

3. The image editing apparatus according to claim 1 or 2 further comprising area selection reception means for receiving selection of a desired one of the image insertion areas,
the image sifting means sifting area fitting images agreeing with the condition specification information for the selected image insertion area from the catalog with reference to the condition specification information therefor,
the image sifting display means carrying out distinctive display of the area fitting images, and
the image selection means receiving selection of the image to be inserted in the selected image insertion area from the area fitting images.

4. An image editing apparatus comprising:
display means for carrying out various kinds of display;
input reception means for receiving input of a plurality of images and a template used as photo album paper and comprising a plurality of pages each having at least one image insertion area, the template having template condition specification information comprising a condition that is common for all the image insertion areas therein and specifies a state of images to be inserted in the image insertion areas, each of the pages having page condition specification information comprising a common condition for the image insertion area or areas therein, and each of the image insertion areas having area condition specification information comprising a condition therefor;
selection reception means for receiving selection of the template, a desired one of the pages in the template, and a desired one of the image insertion areas;
image sifting means for sifting template fitting images agreeing with the template condition specification information from the images by referring to the template condition specification information for the template in the case where the template has been selected, for sifting page fitting images agreeing with the page condition specification information for the selected page from the images with reference to the page condition specification information therefor in the case where the page has been selected, and for sifting area fitting images agreeing with the area condition specification information for the selected image insertion area from the images with reference to the area condition specification information therefor in the case where the image insertion area has been selected;
display control means for displaying the selected template and the selected page together with a catalog of the images on the display means;
image sifting display means for carrying out distinctive display of the template fitting images, the page fitting images, and the area fitting images in the catalog; and
image selection means for receiving selection of the images to be inserted respectively in the image insertion areas from the template fitting images and the page fitting images, and for receiving selection of the image to be inserted in the selected image insertion area from the area fitting images.

5. An image editing apparatus comprising:
display means for carrying out various kinds of display;
input reception means for receiving input of a plurality of images and a template used as photo album paper and comprising a plurality of pages each having at least one image insertion area, each of the image insertion areas having condition specification information comprising a condition for specifying a state of an image to be inserted therein;
relating means for carrying out relating between the images and the conditions in the condition specification information, with reference to the condition specification information for all the image insertion areas in the template;
result storing means for storing a result of the relating;
selection reception means for receiving selection of a desired one of the pages in the template;
image sifting means for making judgment as to whether the condition specification information for the image insertion area or areas in the selected page includes a common condition, and for sifting page fitting images satisfying the common condition from the images by referring to the common condition and the result of the relating in the case where a result of the judgment is affirmative;
display control means for displaying the selected page and a catalog of the images on the display means;
image sifting display means for carrying out distinctive display of the page fitting images in the catalog; and
image selection means for receiving selection of the image or images to be inserted in the image insertion area or areas from the page fitting images.

6. The image editing apparatus according to claim 5,
the selection reception means receiving selection of a desired one of the image insertion areas,
the image sifting means sifting area fitting images agreeing with the condition specification information for the selected image insertion area from the images by referring to the condition specification information for the selected image insertion area and the result of the relating,
the image sifting display means carrying out distinctive display of the area fitting images, and
the image selection means receiving selection of the image to be inserted in the selected image insertion area from the area fitting images.

7. An image editing method comprising the steps of:
receiving input of a plurality of images and a template used as photo album paper and comprising a plurality of pages each having at least one image insertion area, the template added with condition specification information comprising conditions for specifying a state of images to be inserted in the respective image insertion areas;
making judgment as to whether the condition specification information for all the image insertion areas in the template has a common condition and sifting template fitting images satisfying the common condition from the images by referring to the common condition in the case where a result of the judgment is affirmative;
displaying the template and a catalog of the images;
displaying the template fitting images distinctively in the catalog; and
receiving selection of the images to be inserted respectively in the image insertion areas from the template fitting images.

8. An image editing method comprising the steps of:
receiving input of a plurality of images and a template used as photo album paper and comprising a plurality of pages each having at least one image insertion area, the template having template condition specification information comprising a condition that is common for all the image insertion areas therein and specifies a state of images to be inserted in the respective image insertion areas, each of the pages having page condition specification information comprising a common condition for the image insertion area or areas therein, and each of the image insertion areas having area condition specification information comprising a condition therefor;
receiving selection of the template, a desired one of the pages in the template, and a desired one of the image insertion areas;
sifting template fitting images agreeing with the template condition specification information for the template from the images by referring to the template condition specification information in the case where the template has been selected, sifting page fitting images agreeing with the page condition specification information for the selected page from the images with reference to the page condition specification information therefor in the case where the page has been selected, and sifting area fitting images agreeing with the area condition specification information for the selected image insertion area from the images with reference to the area condition specification information therefor in the case where the image insertion area has been selected;
displaying the selected template and the selected page together with a catalog of the images;
displaying the template fitting images, the page fitting images, and the area fitting images distinctively in the catalog; and
receiving selection of the images to be inserted respectively in the image insertion areas from the template fitting images and the page fitting images, and receiving selection of the image to be inserted in the selected image insertion area from the area fitting images.

9. An image editing method comprising the steps of:
receiving input of images and a template used as photo album paper and comprising a plurality of pages each having at least one image insertion area, each of the image insertion areas having condition specification information comprising a condition for specifying a state of an image to be inserted therein;
carrying out relating between the images and the conditions in the condition specification information with reference to the condition specification information for all the image insertion areas in the template;
storing a result of the relating;
receiving selection of a desired one of the pages in the template;
making judgment as to whether the condition specification information for the image insertion area or areas in the selected page includes a common condition, and sifting page fitting images satisfying the common condition from the images by referring to the common condition and the result of the relating in the case where a result of the judgment is affirmative;
displaying the selected page and a catalog of the images;
carrying out distinctive display of the page fitting images in the catalog; and
receiving selection of the image or images to be inserted in the image insertion area or areas from the page fitting images.

10. A program for causing a computer to execute an image editing method comprising the steps of:
receiving input of a plurality of images and a template used as photo album paper and comprising a plurality of pages each having at least one image insertion area, the template added with condition specification information comprising conditions for specifying a state of images to be inserted in the respective image insertion areas;
making judgment as to whether the condition specification information for all the image insertion areas in the template has a common condition and sifting template fitting images satisfying the common condition from the images by referring to the common condition in the case where a result of the judgment is affirmative;
displaying the template and a catalog of the images;
displaying the template fitting images distinctively in the catalog; and
receiving selection of the images to be inserted respectively in the image insertion areas from the template fitting images.

11. A program for causing a computer to execute an image editing method comprising the steps of:
receiving input of a plurality of images and a template used as photo album paper and comprising a plurality of pages each having at least one image insertion area, the template having template condition specification information comprising a condition that is common for all the image insertion areas therein and specifies a state of images to be inserted in the respective image insertion areas, each of the pages having page condition specification information comprising a common condition for the image insertion area or areas therein, and each of the image insertion areas having area condition specification information comprising a condition therefor;
receiving selection of the template, a desired one of the pages in the template, and a desired one of the image insertion areas;
sifting template fitting images agreeing with the template condition specification information for the template from the images by referring to the template condition specification information in the case where the template has been selected, sifting page fitting images agreeing with the page condition specification information for the selected page from the images with reference to the page condition specification information therefor in the case where the page has been selected, and sifting area fitting images agreeing with the area condition specification information for the selected image insertion area from the images with reference to the area condition specification information therefor in the case where the image insertion area has been selected;
displaying the selected template and the selected page together with a catalog of the images;
displaying the template fitting images, the page fitting images, and the area fitting images distinctively in the catalog; and
receiving selection of the images to be inserted respectively in the image insertion areas from the template fitting images and the page fitting images, and receiving selection of the image to be inserted in the selected image insertion area from the area fitting images.

12. A program for causing a computer to execute an image editing method comprising the steps of:
receiving input of images and a template used as photo album paper and comprising a plurality of pages each having at least one image insertion area, each of the image insertion areas having condition specification information comprising a condition for specifying a state of an image to be inserted therein;
carrying out relating between the images and the conditions in the condition specification information with reference to the condition specification information for all the image insertion areas in the template;
storing a result of the relating;
receiving selection of a desired one of the pages in the template;
making judgment as to whether the condition specification information for the image insertion area or areas in the selected page includes a common condition, and sifting page fitting images satisfying the common condition from the images by referring to the common condition and the result of the relating in the case where a result of the judgment is affirmative;
displaying the selected page and a catalog of the images;
carrying out distinctive display of the page fitting images in the catalog; and
receiving selection of the image or images to be inserted in the image insertion area or areas from the page fitting images.
